(19) United States
(12) Patent Application Publication
(10) Pub. No.: US 2025/0038302 A1
(43) Pub. Date: Jan. 30, 2025

(54) HEAT ABSORBING MEMBER AND BATTERY PACK

(71) Applicant: MURATA MANUFACTURING CO., LTD., Kyoto (JP)

(72) Inventor: Yoshiyuki BANNAI, Kyoto (JP)

(21) Appl. No.: 18/917,409

(22) Filed: Oct. 16, 2024

Related U.S. Application Data
(63) Continuation of application No. PCT/JP2023/032411, filed on Sep. 5, 2023.

(30) Foreign Application Priority Data
Nov. 2, 2022 (JP) 2022-176032

(51) Int. Cl. H01M 10/6567; H01M 10/613; H01M 50/682

(52) U.S. Cl. CPC H01M 10/6567; H01M 10/613; H01M 50/682

(57) ABSTRACT

A heat absorbing member 50 includes a heat absorbing agent 51 and an exterior member 52 accommodating the heat absorbing agent 51, the exterior member 52 has a portion 61 in contact with an object, and the portion 61 has a groove 64.

### CROSS REFERENCE TO RELATED APPLICATIONS

The present application is a continuation of PCT patent application no. PCT/JP2023/032411, filed on Sep. 5, 2023, which claims priority to Japanese patent application no. 2022-176032, filed on Nov. 2, 2022, the entire contents of which are incorporated herein by reference.

### BACKGROUND

The present disclosure relates to a heat absorbing member and a battery pack.

An example of a battery pack, a battery module including a heat absorbing member and a plurality of battery cells, where the heat absorbing member includes a heat absorbing agent and an exterior film enclosing the heat absorbing agent. At the time of abnormal heat generation of a secondary battery, the exterior film is cleaved, and temperature of the secondary battery is lowered by the heat absorbing agent.

### SUMMARY

The present disclosure relates to a heat absorbing member and a battery pack.

The exterior film (exterior member) is desirably easily cleaved at the time of abnormal heat generation of a secondary battery.

The present disclosure, in an embodiment, relates to providing a heat absorbing member that is easily cleaved when an object generates heat.

A heat absorbing member of the present disclosure includes a heat absorbing agent, and an exterior member that accommodates the heat absorbing agent. The exterior member has a first portion that is in contact with an object, and the first portion has a groove.

A battery pack of the present disclosure includes the heat absorbing member and a secondary battery, and the object is the secondary battery.

According to the present disclosure, the heat absorbing member can be easily cleaved at the time of abnormal heat generation of an object.

### BRIEF DESCRIPTION OF THE FIGURES

FIG. 1 is an exploded perspective view of a battery pack according to an embodiment of the present disclosure.

FIG. 2 is an exploded perspective view of a battery unit illustrated in FIG. 1.

FIG. 3 is a longitudinal sectional view of a secondary battery and a lead plate illustrated in FIG. 2.

FIG. 4 is a transverse sectional view of a heat absorbing member.

FIG. 5 is an exploded perspective view of an exterior member.

FIG. 6 is a perspective view of a first exterior member as viewed from an outer surface.

FIG. 7 is a partial sectional view of the first exterior member.

FIG. 8 is an enlarged sectional view of a part of the first exterior member.

FIG. 9 is a schematic view illustrating a process of formation of the first exterior member by injection molding.

FIG. 10 is a diagram illustrating a position of a projecting portion according to another variation of an embodiment of the present disclosure.

FIG. 11 is a diagram illustrating a position of a projecting portion according to an embodiment of the present disclosure.

FIG. 12 is a diagram illustrating a position of the projecting portion according to an embodiment of the present disclosure.

FIG. 13 is an exploded perspective view of a battery unit according to an embodiment of the present disclosure.

FIG. 14 is an exploded perspective view of the exterior member.

FIG. 15 is a perspective view of the first exterior member.

FIG. 16 is a sectional view of the first exterior member taken along line A-A illustrated in FIG. 15.

FIG. 17 is a sectional view of the first exterior member taken along line B-B illustrated in FIG. 16.

FIG. 18 is a schematic view illustrating a process of formation of the first exterior member by injection molding.

FIG. 19 is a diagram illustrating a position of the projecting portion according to another variation of an embodiment of the present disclosure.

FIG. 20 is a diagram illustrating a position of the projecting portion according to an embodiment of the present disclosure.

### DETAILED DESCRIPTION

The present application will be described below in further detail according to an embodiment. Each embodiment is illustrative, and replacement and combination of a part of configurations shown in different embodiments can be performed.

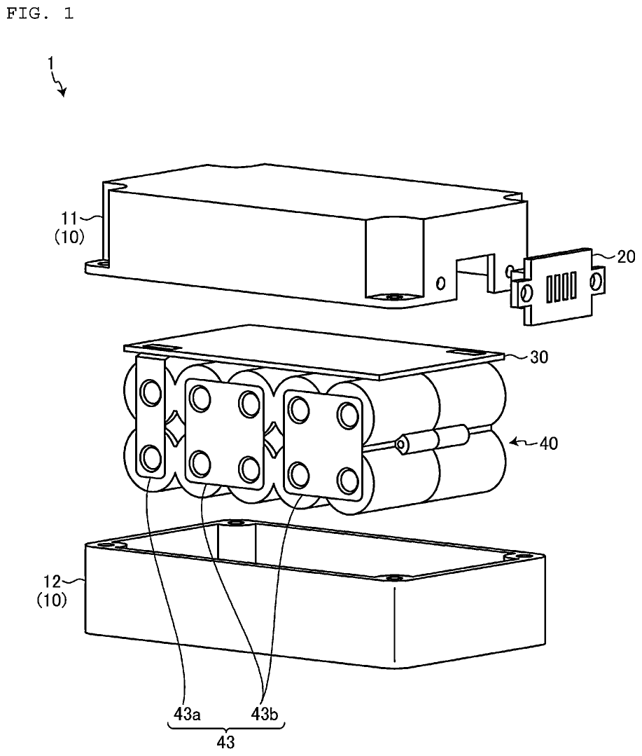

FIG. 1 is an exploded perspective view of a battery pack 1 according to a first embodiment of the present disclosure. The battery pack 1 can be applied as a power source to an external device (not illustrated) such as an electronic device, an electric vehicle, and an electric tool. The battery pack 1 includes an exterior case 10, a connector 20, a control board 30, and a battery unit 40.

The exterior case 10 has a box shape and accommodates the control board 30 and the battery unit 40. The exterior case 10 includes a first case portion 11 and a second case portion 12.

The connector 20 is attached to the exterior case 10. The connector 20 electrically connects an external device and the battery unit 40 via the control board 30, and supplies (discharges) power of the battery unit 40 to the external device. Further, the connector 20 electrically connects a power supply (for example, a commercial power supply) and the battery unit 40 via the control board 30, and supplies (charges) power from the power supply to the battery unit 40. The control board 30 controls charging and discharging of the battery unit 40.

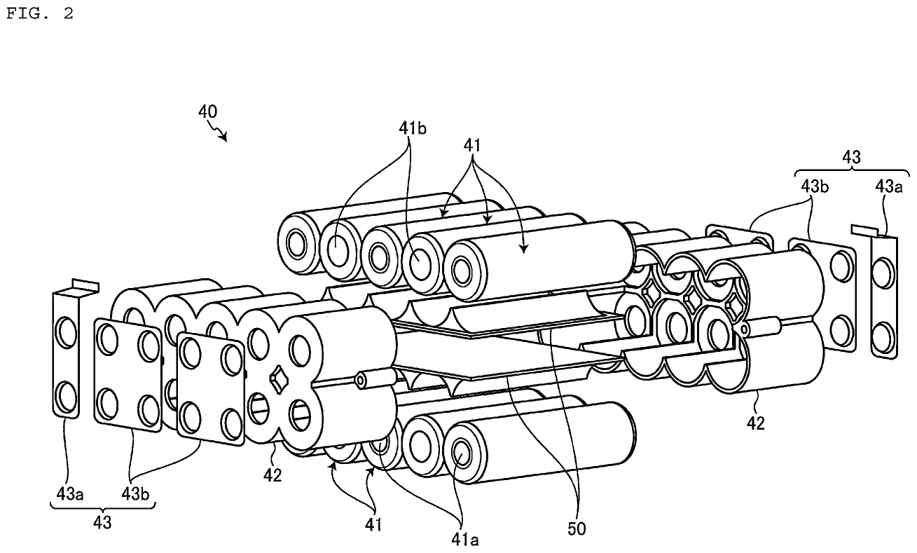

FIG. 2 is an exploded perspective view of the battery unit 40 illustrated in FIG. 1. The battery unit 40 includes a plurality of secondary batteries 41, a holder 42, a plurality of lead plates 43, and a plurality of heat absorbing members 50.

The secondary battery 41 is, for example, a lithium ion battery. The secondary battery 41 has a cylindrical shape. In the first embodiment, the number of the secondary batteries 41 is ten, but it goes without saying that the number is not limited to ten.

A plurality of the secondary batteries 41 are arranged in parallel. That is, axes of a plurality of the secondary batteries 41 are substantially parallel to each other. In the first embodiment, a plurality of the secondary batteries 41 are arranged in two rows. Further, in a plurality of the secondary batteries 41, an orientation of a positive electrode terminal 41a and an orientation of a negative electrode terminal 41b are arranged in a predetermined orientation.

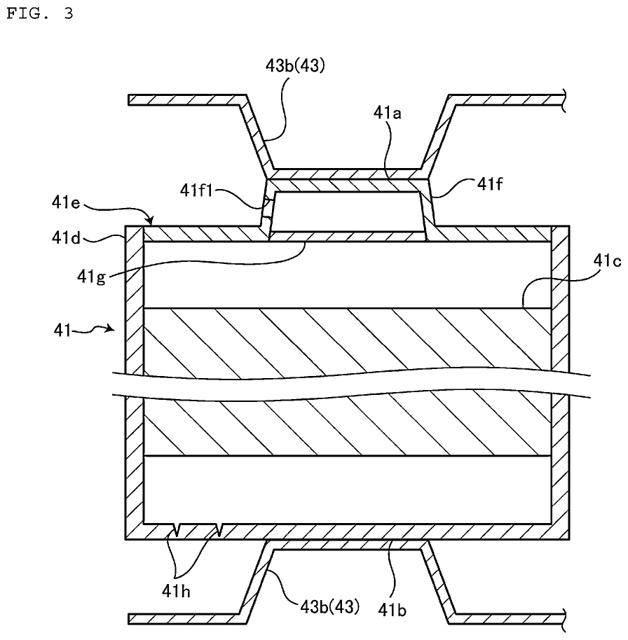

FIG. 3 is a longitudinal sectional view of the secondary battery 41 illustrated in FIG. 2 and the lead plate 43. In FIG. 3, the holder 42 and the heat absorbing member 50 are not illustrated. The secondary battery 41 includes an electrode assembly 41c, a can 41d, and a lid 41e. The can 41d and the lid 41e are made from, for example, iron, stainless steel, or aluminum, and have conductivity.

The electrode assembly 41c is formed by laminating and winding a plurality of sheet-like positive electrodes (not illustrated) and a plurality of sheet-like negative electrodes (not illustrated) with a separator (not illustrated) interposed therebetween.

The can 41d has a tubular shape having an opening on one end side. The can 41d is electrically connected to a negative electrode of the electrode assembly 41c with current collecting foil (not illustrated) interposed therebetween. A central portion of an end surface on another end side of the can 41d is the negative electrode terminal 41b of the secondary battery 41.

The lid 41e has a plate shape and covers an opening on one end side of the can 41d. The lid 41e and the can 41d are electrically insulated by an insulating member (not illustrated). The lid 41e is electrically connected to a positive electrode of the electrode assembly 41c with current collecting foil interposed therebetween.

The lid 41e has a protruding portion 41f and a cleavage valve 41g. The protruding portion 41f is located at a central portion of the lid 41e. A protruding end surface of the protruding portion 41f is the positive electrode terminal 41a of the secondary battery 41. Further, a hole 41f1 that allows the inside and the outside of the secondary battery 41 to communicate with each other is provided in the protruding portion 41f. Note that a plurality of the holes 41f1 may be provided.

The cleavage valve 41g is arranged inside the protruding portion 41f inside the secondary battery 41. Specifically, the cleavage valve 41g is arranged at a position that separates a space communicating with the hole 41f1 and a space where the electrode assembly 41c is located inside the secondary battery 41. When internal pressure of the secondary battery 41 becomes a predetermined value or more, the cleavage valve 41g is cleaved to be in an open state.

Further, a battery thin portion 41h is provided in a portion on another end side of the can 41d. The battery thin portion 41h is a portion having small thickness in a portion on the other end side of the can 41d. The portion on the other end side of the can 41d is cleaved from the battery thin portion 41h when internal pressure of the secondary battery 41 becomes high. For example, in a case where the cleavage valve 41g is not in an open state when internal pressure of the secondary battery 41 becomes a predetermined value or more, when the internal pressure of the secondary battery 41 further increases, the portion on the other end side of the can 41d is cleaved from the battery thin portion 41h.

The holder 42 illustrated in FIG. 2 holds a plurality of the secondary batteries 41. There are two of the holders 42 which mainly hold an outer peripheral surface of the secondary battery 41. Specifically, the holder 42 holds a portion of the secondary battery 41 other than a portion of the can 41d provided with the positive electrode terminal 41a, the negative electrode terminal 41b, the protruding portion 41f, and the battery thin portion 41h.

The lead plate 43 electrically connects a plurality of the secondary batteries 41 in series or in parallel. Further, the lead plate 43 electrically connects a plurality of the secondary batteries 41 and the control board 30. The lead plate 43 includes a first lead plate 43a and a second lead plate 43b. The first lead plate 43a electrically connects two of the secondary batteries 41. The second lead plate 43b electrically connects four of the secondary batteries 41. It goes without saying that the number of the secondary batteries 41 electrically connected by the first lead plate 43a and the second lead plate 43b is not limited to the above numbers.

### <Heat Absorbing Member 50>

The battery pack 1 includes two of the heat absorbing members 50. The heat absorbing member 50 is disposed between a plurality of the secondary batteries 41 arranged in two rows. The heat absorbing member 50 is in contact with an object. The object is the secondary battery 41. The heat absorbing member 50 is in contact with a plurality of the secondary batteries 41 arranged in one row. It goes without saying that the number of the heat absorbing members 50 is not limited to two. Further, the heat absorbing member 50 may be disposed outside a plurality of the secondary batteries 41 arranged in two rows.

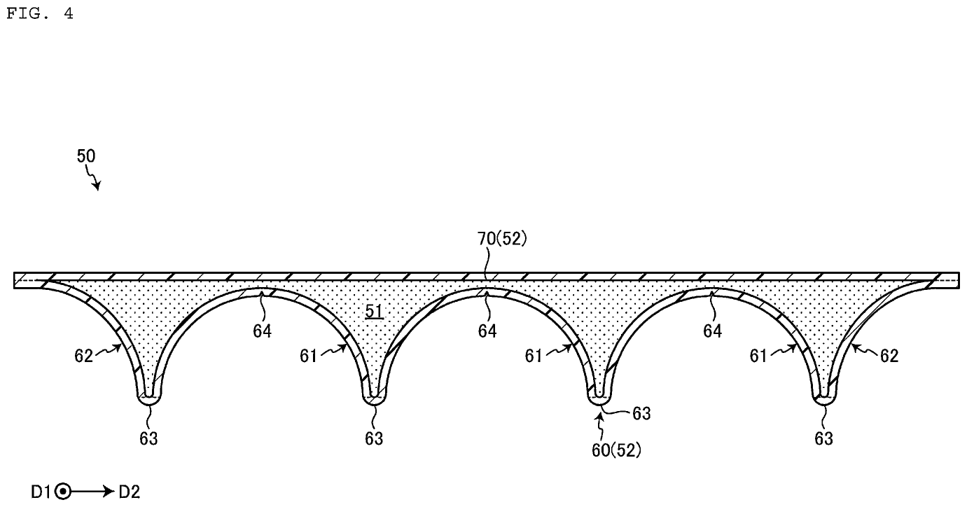

FIG. 4 is a transverse sectional view of the heat absorbing member 50. A first direction D1 and a second direction D2 illustrated in the diagram are straight and orthogonal to each other. FIG. 4 illustrates a sectional shape of the heat absorbing member 50 when the heat absorbing member 50 is cut along a plane orthogonal to the first direction D1. Note that in each of the first direction D1 and the second direction D2, a side indicated by an arrow is defined as a positive side, and a side opposite to the positive side is defined as a negative side. The heat absorbing member 50 absorbs heat of the secondary battery 41 (details will be described later). The heat absorbing member 50 includes a heat absorbing agent 51 and an exterior member 52 that accommodates the heat absorbing agent 51.

The heat absorbing agent 51 contains a substance that absorbs heat generated from the secondary battery 41. A main component of the heat absorbing agent 51 is, for example, liquid such as water. The heat absorbing agent 51 may contain a gelling agent, a surfactant, and an anti-freezing agent. Note that the heat absorbing agent 51 may or may not have fluidity.

FIG. 5 is an exploded perspective view of the exterior member 52. The exterior member 52 includes a first exterior member 60 and a second exterior member 70. A material of the first exterior member 60 and the second exterior member 70 is a thermoplastic resin having electrical insulation property. A material of the first exterior member 60 and the second exterior member 70 is, for example, a single body of polyethylene terephthalate. A material of the first exterior member 60 and the second exterior member 70 may be synthetic resin containing at least one of polyethylene terephthalate, polypropylene, polyethylene, and polystyrene. The first exterior member 60 and the second exterior member 70 are formed by injection molding.

As illustrated in FIGS. 4 and 5, the first exterior member 60 includes a plurality of (specifically, three) portions 61, a plurality of (specifically, two) portions 62, and a plurality of (specifically, four) portions 63. The portion 61 corresponds to a “first portion”. The portion 63 corresponds to a “second portion”. The portion 61, the portion 62, and the portion 63 are integral.

The portion 61 and the portion 62 are in contact with the secondary battery 41 as an object. At least a part of the portion 61 and the portion 62 is in contact with at least a part of an outer peripheral surface of the secondary battery 41. It goes without saying that the number of the portions 61 is not limited to three, the number of the portions 62 is not limited to two, and the number of the portions 63 is not limited to four.

The portion 61 extends along the first direction D1. As illustrated in FIG. 4, a sectional shape of each of the portions 61 when cut along a plane orthogonal to the first direction D1 is a recessed shape recessed toward the inner side of the exterior member 52. That is, each of the portions 61 is recessed from the first exterior member 60 side toward the second exterior member 70 side. Specifically, a sectional shape of the portion 61 illustrated in FIG. 4 is a semicircular shape. That is, that a sectional shape of the portion 61 is a recessed shape means that the sectional shape of the portion 61 is a semicircular shape.

An outer surface of the portion 61 which is a part of an outer surface of the exterior member 52 is a curved surface along an outer peripheral surface of the secondary battery 41. An outer surface of the portion 61 is in contact with an outer peripheral surface of the secondary battery 41 having a cylindrical shape. By the above, a contact area between the portion 61 and the secondary battery 41 can be increased.

Further, three of the portions 61 are arranged in parallel along the second direction D2. By the above, the heat absorbing member 50 can be disposed between a plurality of the secondary batteries 41, and the battery pack 1 can be prevented from becoming large in size.

The portion 62 extends along the first direction D1. As illustrated in FIG. 4, a sectional shape of the portion 62 when cut along a plane orthogonal to the first direction D1 is a recessed shape recessed toward the inner side of the exterior member 52. That is, the portion 62 is recessed from the first exterior member 60 side toward the second exterior member 70 side. Specifically, a sectional shape of the portion 62 illustrated in FIG. 4 is a quarter circular shape. That is, that a sectional shape of the portion 62 is a recessed shape means that a sectional shape of the portion 62 is a quarter circular shape. It goes without saying that sectional shapes of the portion 61 and the portion 62 are not limited to a recessed shape.

An outer surface of the portion 62 which is a part of an outer surface of the exterior member 52 is a curved surface along an outer peripheral surface of the secondary battery 41 which is an object. An outer surface of the portion 62 is in contact with an outer peripheral surface of the secondary battery 41 having a cylindrical shape. By the above, a contact area between the portion 62 and the secondary battery 41 can be increased. Further, two of the portions 62 are disposed on both sides of three of the portions 61 in the second direction D2.

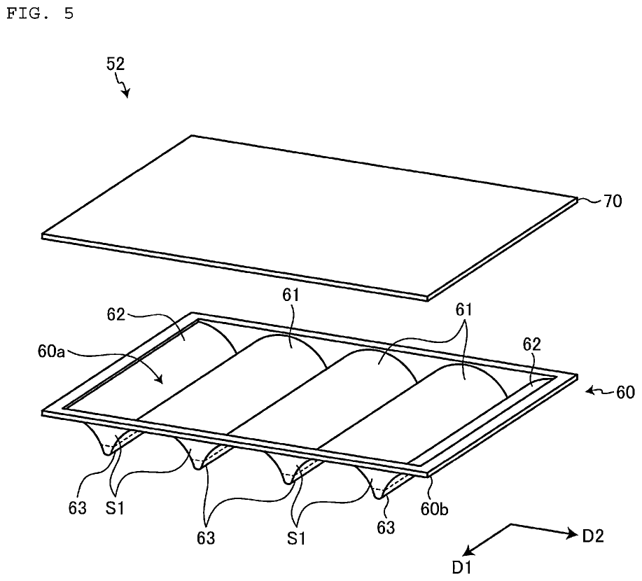

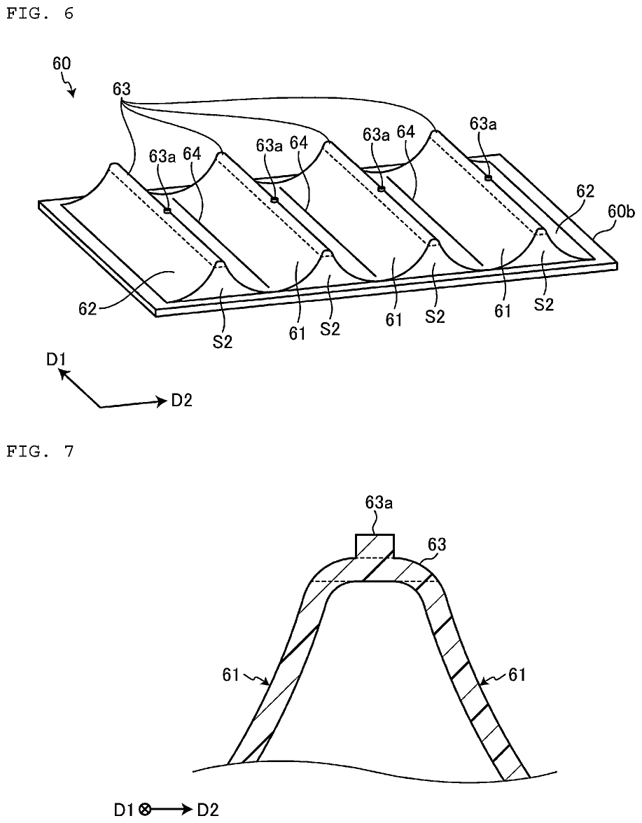

FIG. 6 is a perspective view of the first exterior member 60 as viewed from an outer surface. As illustrated in FIGS. 4 and 6, the portion 63 is disposed on each of both sides of the portion 61 in a direction orthogonal to the first direction D1 (that is, the second direction D2) and is continuous from the portion 61. The portion 63 extends along the first direction D1. The portion 63 is not in contact with an outer peripheral surface of the secondary battery 41 having a cylindrical shape. Note that the portion 63 may be in contact with an outer peripheral surface of the secondary battery 41 having a cylindrical shape.

The portion 63 continuous from each of two of the portions 61 adjacent to each other in the second direction D2 is integrated. That is, the portion 63 connects two of the portions 61 adjacent to each other in the second direction D2. Further, the portion 62 adjacent to the portion 61 in the second direction D2 is continuous from the portion 63. That is, the portion 63 connects the portion 61 and the portion 62 adjacent to each other in the second direction D2.

FIG. 7 is a partial sectional view of the first exterior member 60. As illustrated in FIGS. 6 and 7, each of four of the portions 63 has a projecting portion 63a. The projecting portion 63a is disposed in a central portion in the first direction D1 of the portion 63. Specifically, the projecting portion 63a is a gate mark.

Further, as illustrated in FIG. 6, the portion 61 has a groove 64. The groove 64 is in a central portion in the second direction D2 of the portion 61 and extends substantially along the first direction D1. The groove 64 is in at least a part of the portion 61 in the first direction D1, and the groove 64 is specifically a weld line.

FIG. 8 is an enlarged sectional view of a part of the first exterior member 60. The groove 64 is on an outer surface of the portion 61. Note that an outer surface of the groove 64 is not in contact with the secondary battery 41.

Further, as illustrated in FIG. 5, the first exterior member 60 has a recessed portion 60a and a flange portion 60b. The recessed portion 60a has a recessed shape with an inner surface of the portion 61, an inner surface of the portion 62, and an inner surface of the portion 63 as a bottom surface. An inner surface of the portion 61, an inner surface of the portion 62, and an inner surface of the portion 63 are a part of an inner surface of the exterior member 52. The flange portion 60b is formed over the entire circumference of a peripheral edge of the recessed portion 60a.

Further, as illustrated in FIG. 5, an outer surface of the first exterior member 60 has a plurality of end surfaces S1. A plurality of the end surfaces S1 are on the positive side in the first direction D1 of the portion 61, the portion 62, and the portion 63. A plurality of the end surfaces S1 are arranged along the second direction D2. Note that a plurality of the end surfaces S1 may be continuously formed to form one end surface S1.

Further, as illustrated in FIG. 6, an outer surface of the first exterior member 60 has a plurality of end surfaces S2. A plurality of the end surfaces S2 are on the negative side in the first direction D1 of the portion 61, the portion 62, and the portion 63. A plurality of the end surfaces S2 are arranged along the second direction D2. Note that a plurality of the end surfaces S2 may be continuously formed to form one end surface S2. Each of a plurality of the portions 63 is sandwiched between the end surface S1 and the end surface S2 in the first direction D1. The number of the end surfaces S1 and the number of the end surfaces S2 are equal to the number of the portions 63.

The second exterior member 70 has a plate shape that covers the recessed portion 60a of the first exterior member 60. A peripheral edge portion of the second exterior member 70 is joined to the flange portion 60b. Specifically, a peripheral edge portion of the second exterior member 70 and the flange portion 60b are joined by, for example, vibration welding, heat welding, or the like. By the above, the exterior member 52 accommodates the heat absorbing agent 51 in a sealed state.

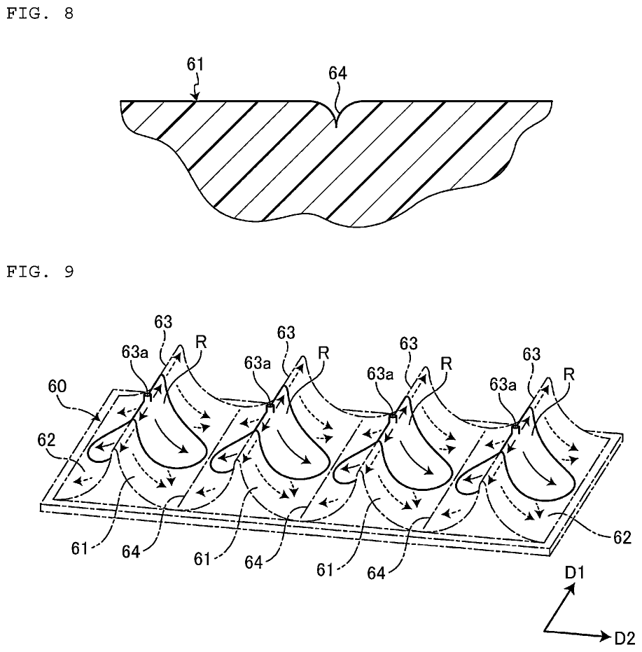

Next, a process of formation of the groove 64 in the first exterior member 60 will be described. FIG. 9 is a schematic view illustrating a process of formation of the first exterior member 60 by injection molding. An arrow illustrated in FIG. 9 indicates flow of resin R which is a material of the first exterior member 60 during molding in a cavity of a mold of the first exterior member 60.

A gate of a mold of the first exterior member 60 is located at a position corresponding to the projecting portion 63a of the first exterior member 60. That is, there are four gates of the mold. The gate of the mold is what is called a pin gate.

The resin R flows into a cavity of the mold from each of the four gates, and flows from the gate (projecting portion 63a) toward a position corresponding to both sides in the first direction D1 and a position corresponding to both sides in the second direction D2 as indicated by an arrow of a solid line in FIG. 9. Further, the resin R flowing in from each of two gates adjacent to each other in the second direction D2 hits at a position corresponding to a central portion of the portion 61. At this time, temperature of the resin R is lower on the surface side of the resin R than inside the resin R, so that solidification of the resin R is advanced. Therefore, the resin R is not sufficiently fused on the surface side of the resin R, and the groove 64 is generated on a surface of the portion 61.

Further, the resin R flows toward a position corresponding to both sides in the first direction D1 and a position corresponding to a central portion in the second direction D2 of the portion 61 as indicated by an arrow of a broken line in FIG. 9. When the resin R further hits at a position corresponding to the central portion in the second direction D2 of the portion 61, the groove 64 extends along the first direction D1.

Note that when the first exterior member 60 is taken out from a mold, the first exterior member 60 and a gate are separated from each other, and the projecting portion 63a that is a gate mark is formed on the first exterior member 60. As described above, a gate is provided at a position corresponding to the projecting portion 63a of the first exterior member 60, that is, at each of positions corresponding to a central portion in the first direction D1 of the portion 63 on both end sides in the second direction D2 of the portion 61, and hence the groove 64 can be formed in the portion 61.

Next, operation of the battery pack 1 in a case where the secondary battery 41 abnormally generates heat will be described. Abnormal heat generation of the secondary battery 41 is caused by, for example, a short circuit of the secondary battery 41 or heating from the outside.

The heat absorbing member 50 is in contact with the secondary battery 41. For this reason, due to abnormal heat generation of the secondary battery 41, heat of the secondary battery 41 is transmitted to the heat absorbing member 50, and temperature of the exterior member 52 and temperature of the heat absorbing agent 51 increase. Internal pressure of the heat absorbing member 50 increases due to temperature increase of the heat absorbing agent 51.

Here, in the portion 61, thickness of a portion where the groove 64 is formed is less than thickness of another portion (see FIG. 8). For this reason, in the portion 61, strength of a portion where the groove 64 is formed is less than strength of another portion. Further, internal pressure of the heat absorbing member 50 uniformly acts on an inner surface of the portion 61.

Therefore, when internal pressure of the heat absorbing member 50 increases, the first exterior member 60 is cleaved with the groove 64 as a starting point. By the above, the heat absorbing agent 51 leaks from the exterior member 52 and adheres to the secondary battery 41. Furthermore, the heat absorbing agent 51 adhering to the secondary battery 41 evaporates, and temperature of the secondary battery 41 decreases.

As described above, the groove 64 serves as a starting point of cleavage of the first exterior member 60, so that the heat absorbing member 50 can be easily cleaved at the time of abnormal heat generation of the secondary battery 41. Further, the portion 61 in contact with the secondary battery 41 at the time of abnormal heat generation of the secondary battery 41 is softened by being directly heated by the secondary battery 41. Therefore, the first exterior member 60 is cleaved more easily with the groove 64 as a starting point.

Note that in a case where the heat absorbing agent 51 has fluidity, as the heat absorbing agent 51 flows along an outer surface of the secondary battery 41, a contact area between the heat absorbing agent 51 and the secondary battery 41 increases as compared with a case where the heat absorbing agent 51 does not have fluidity, and temperature of the secondary battery 41 can be lowered early.

Further, there is also a case where the cleavage valve 41g is opened due to abnormal heat generation of the secondary battery 41, and the exterior member 52 is heated by gas, a spark, or the like ejected from the cleavage valve 41g, and cleaved with a portion of the exterior member 52 heated by a spark or the like as a starting point. The spark is generated from a part of, for example, current collecting foil and an electrode.

For example, the groove 64 may be at a portion other than a central portion in the second direction D2 of the portion 61, and may extend along a direction inclined with the first direction D1. Further, the groove 64 may be curved in plan view of the first exterior member 60. Furthermore, the groove 64 may be on an inner surface of the portion 61.

In the portion 61, regardless of a position of the groove 64, thickness of a portion where the groove 64 is formed is less than thickness of another portion. For this reason, in the portion 61, strength of a portion where the groove 64 is formed is less than strength of another portion. Further, as described above, internal pressure of the heat absorbing member 50 uniformly acts on an inner surface of the portion 61. Therefore, when internal pressure of the heat absorbing member 50 increases, regardless of a position of the groove 64, the first exterior member 60 is cleaved with the groove 64 as a starting point.

Further, the groove 64 may also be in the portion 62. In this case, the first exterior member 60 may further have the projecting portion 63a on the side opposite to the portion 63 with the portion 62 interposed therebetween in the second direction D2. According to this, the groove 64 is formed also in the portion 62 similarly to the portion 61, and the groove 64 serves as a starting point of cleavage of the first exterior member 60 as in the first embodiment at the time of abnormal heat generation of the secondary battery 41, so that the heat absorbing member 50 can be easily cleaved at the time of abnormal heat generation of the secondary battery 41.

Further, the projecting portion 63a may be located at a position other than a central portion of the portion 63 in the first direction D1, or a plurality of the projecting portions 63a may be located in one of the portions 63.

When the portion 63 has the projecting portion 63a regardless of positions and the number of the projecting portions 63a, the resin R flowing in from each of gates (the projecting portions 63a) at the time of molding of the first exterior member 60 hits at a position corresponding to the portion 61. That is, the groove 64 is formed in the portion 61. By the above, as in the first embodiment, the first exterior member 60 is cleaved with the groove 64 as a starting point.

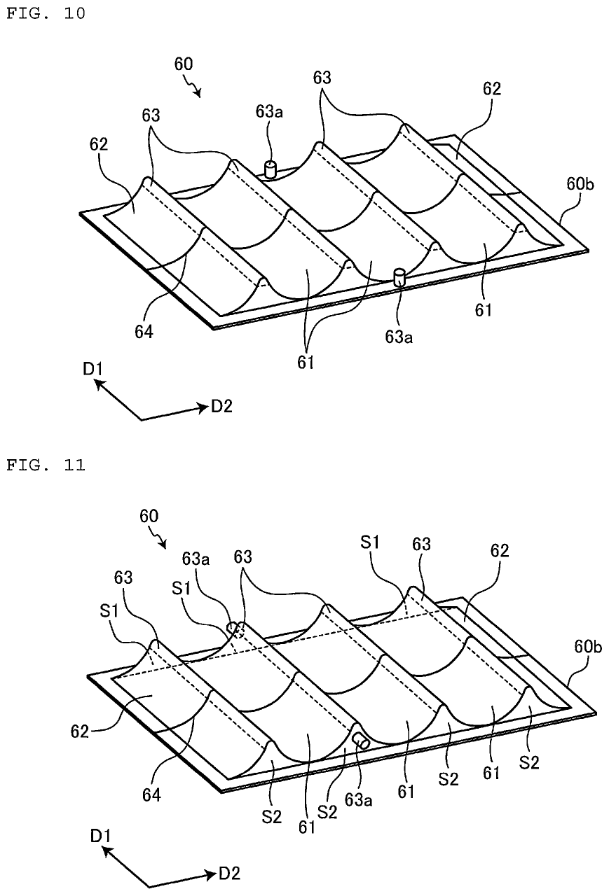

FIG. 10 is a diagram illustrating a position of the projecting portion 63a according to another variation of the first embodiment of the present disclosure. In the present variation, the number of the projecting portions 63a is two. Further, the projecting portion 63a is disposed on the flange portion 60b. Two of the projecting portions 63a are arranged on both sides with the portion 61 interposed therebetween at a central portion in the second direction D2. In this case, the groove 64 is formed so as to extend along the second direction D2 in a central portion in the first direction D1 of the first exterior member 60.

FIG. 11 is a diagram illustrating a position of the projecting portion 63a according to another variation of the first embodiment of the present disclosure. In the present variation, the number of the projecting portions 63a is two. When the first exterior member 60 is viewed along the first direction D1, two of the projecting portions 63a overlap each other. The projecting portion 63a is disposed on each of the end surface S1 and the end surface S2 overlapping each other when the first exterior member 60 is viewed along the first direction D1. In this case, the groove 64 is formed so as to extend along the second direction D2 in a central portion in the first direction D1 of the first exterior member 60.

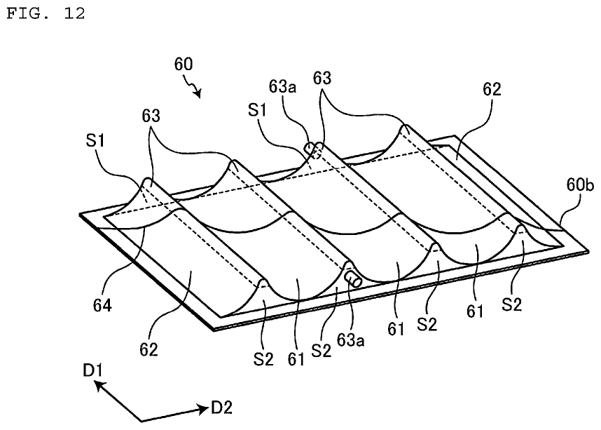

FIG. 12 is a diagram illustrating a position of the projecting portion 63a according to another variation of the first embodiment of the present disclosure. In the present variation, the number of the projecting portions 63a is two. When the first exterior member 60 is viewed along the first direction D1, two of the projecting portions 63a are disposed at positions not overlapping each other. One of the projecting portions 63a is disposed on a third one of the end surfaces S1 from the negative side in the second direction D2 among a plurality of the end surfaces S1. On the other hand, another one of the projecting portions 63a is disposed on a second one of the end surfaces S2 from the negative side in the second direction D2. In this case, the groove 64 is formed so as to be directed further from the positive side to the negative side in the first direction D1 as it goes from the negative side to the positive side in the second direction D2 in the first exterior member 60. Also in other variations illustrated in FIGS. 10, 11, and 12, the groove 64 serves as a starting point of cleavage of the first exterior member 60 at the time of abnormal heat generation of the secondary battery 41, so that the heat absorbing member 50 can be easily cleaved at the time of abnormal heat generation of the secondary battery 41.

Further, the groove 64 may be formed not by a weld line but by a recessed shape of a mold. In the groove 64 as described above as well, the groove 64 serves as a starting point of cleavage of the first exterior member 60 as described above at the time of abnormal heat generation of the secondary battery 41, so that the heat absorbing member 50 can be easily cleaved at the time of abnormal heat generation of the secondary battery 41.

Next, regarding the battery pack 1 and a heat absorbing member 150 of a second embodiment, a difference from the heat absorbing member 150 of the first embodiment will be mainly described.

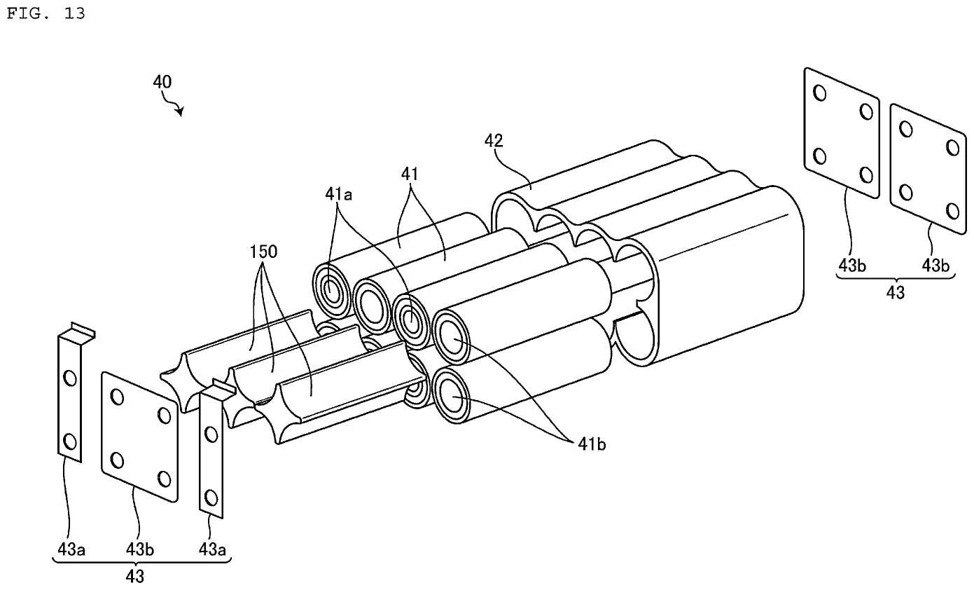

FIG. 13 is an exploded perspective view of the battery unit 40 according to the second embodiment of the present disclosure. In the battery unit 40 of the second embodiment, four of the secondary batteries 41 are arranged in two rows, and three of the heat absorbing members 150 are provided.

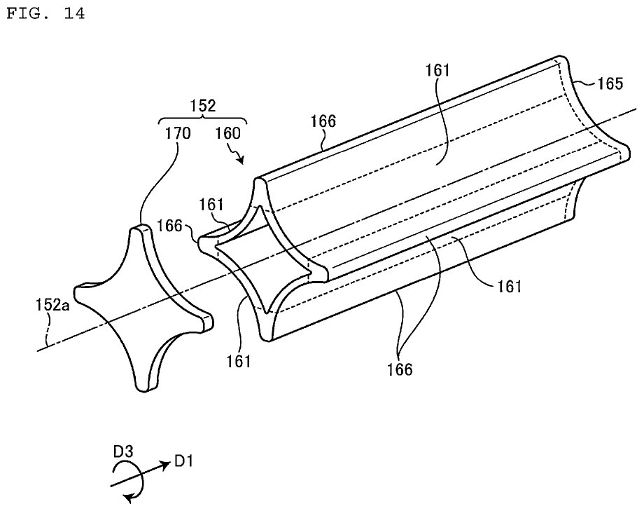

FIG. 14 is an exploded perspective view of an exterior member 152. The exterior member 152 has a hollow columnar shape extending along the first direction D1. A central axis 152a of the exterior member 152 extends along the first direction D1. A third direction D3 around the central axis 152a of the exterior member 152 illustrated in FIG. 14 corresponds to a circumferential direction of the exterior member 152.

A first exterior member 160 has a tubular shape having a portion 165 intersecting the first direction D1 on a first end side in the first direction D1, a plurality of (specifically, four) portions 161 extending along the first direction D1, and a plurality of (specifically, four) portions 166 extending along the first direction D1. The portion 165 corresponds to a “third portion”. The portion 161 corresponds to a “first portion”. The portion 166 corresponds to a “fourth portion”. The portion 165, a plurality of the portions 161, and a plurality of the portions 166 are integral. The first exterior member 160 has an opening on a second end side in the first direction D1.

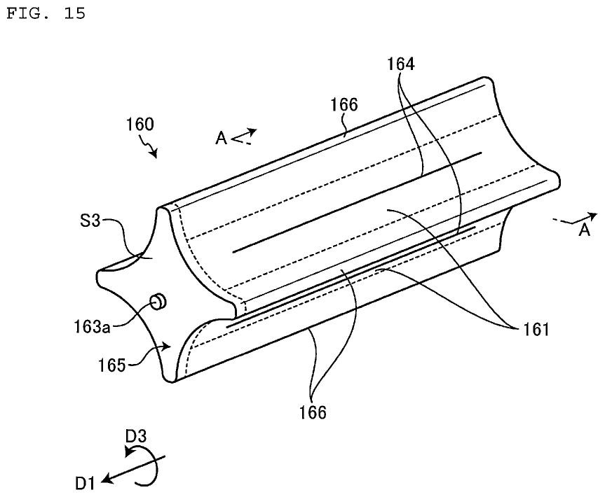

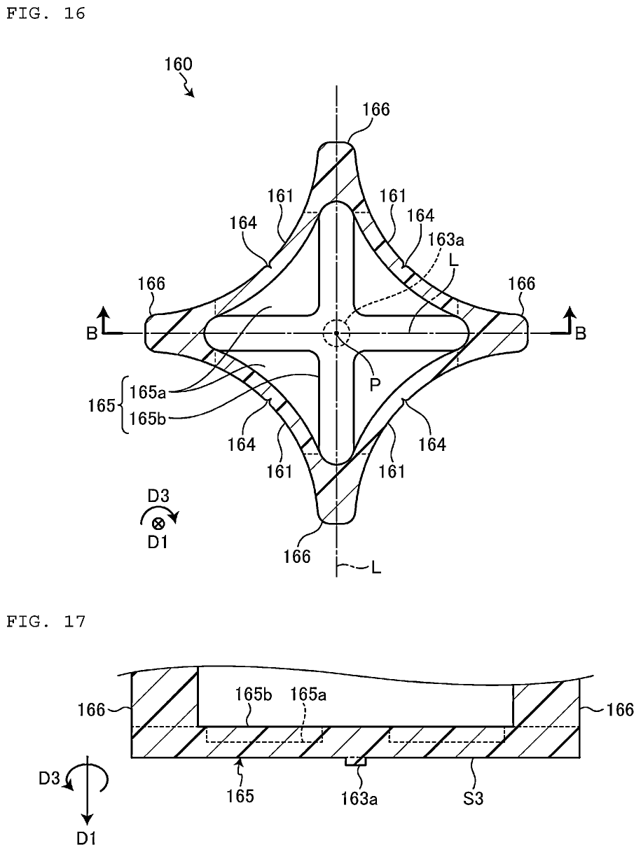

FIG. 15 is a perspective view of the first exterior member 160. FIG. 16 is a sectional view of the first exterior member 160 taken along line A-A illustrated in FIG. 15. FIG. 16 illustrates a sectional shape of the first exterior member 160 when cut along a plane orthogonal to the first direction D1. As illustrated in FIGS. 15 and 16, four of the portions 161 are disposed continuously from the portion 165 and are arranged in the circumferential direction (the third direction D3) of the exterior member 152. By the above, the heat absorbing member 150 can be disposed between a plurality of the secondary batteries 41 (see FIG. 13), and the battery pack 1 can be prevented from becoming large in size.

As illustrated in FIGS. 14 to 16, in the second embodiment, a sectional shape of each of the portions 161 when cut along a plane orthogonal to the first direction D1 is a recessed shape recessed toward the inner side of the first exterior member 160. In other words, each of the portions 161 is recessed toward the central axis 152a of the exterior member 152. A sectional shape of the portion 161 when cut along a plane orthogonal to the first direction D1 is a quarter circular shape.

Further, a central portion of the portion 161 in the circumferential direction of the exterior member 152 has a groove 164 which is a weld line extending substantially along the first direction D1.

The portion 166 is disposed on each of both sides of the portion 161 in the circumferential direction of the exterior member 152, and is continuous from the portion 161. The portion 166 continuous from each of two of the portions 161 adjacent to each other in the circumferential direction of the exterior member 152 is integrated. That is, the portion 166 connects two of the portions 161 adjacent to each other in the circumferential direction of the exterior member 152. Further, thickness of the portion 166 is larger than thickness of the portion 161.

Four of the portions 166 are arranged continuously from the portion 165. The portion 166 is not in contact with an outer peripheral surface of the secondary battery 41 having a cylindrical shape. Note that the portion 166 may be in contact with an outer peripheral surface of the secondary battery 41 having a cylindrical shape.

FIG. 17 is a sectional view of the first exterior member 160 taken along line B-B illustrated in FIG. 16. As illustrated in FIGS. 16 and 17, the portion 165 integrally includes a projecting portion 163a, a base portion 165a, and a coupling portion 165b. The projecting portion 163a is a gate mark and is on an outer surface S3 facing the positive side in the first direction D1 in the portion 165. Further, the projecting portion 163a is located at a central portion of the portion 165 in plan view of the portion 165. The base portion 165a is connected to an end portion on a first end side in the first direction D1 of the portion 161.

Thickness of the coupling portion 165b is larger than thickness of the base portion 165a. An inner surface of the coupling portion 165b is located further on the inner side of the first exterior member 160 than an inner surface of the base portion 165a.

The coupling portion 165b couples four of the portions 166 and the projecting portion 163a. Specifically, as illustrated in FIG. 16, the coupling portion 165b connects two of the portions 166 facing each other in plan view of the portion 165 among four of the portions 166, and overlaps two diagonal lines L intersecting each other. That is, the coupling portion 165b has an X shape in plan view of the portion 165. Further, the projecting portion 163a overlaps an intersection P of two of the diagonal lines L in plan view of the portion 165.

As illustrated in FIG. 14, a second exterior member 170 has a plate shape and covers an opening of the first exterior member 160. A peripheral edge portion of the second exterior member 170 is joined to an end portion on a second end side of the first exterior member 160 in the first direction D1. Specifically, a peripheral edge portion of the second exterior member 170 and an end portion of the first exterior member 160 are joined by, for example, vibration welding, heat welding, or the like. By the above, the heat absorbing agent 51 is sealed.

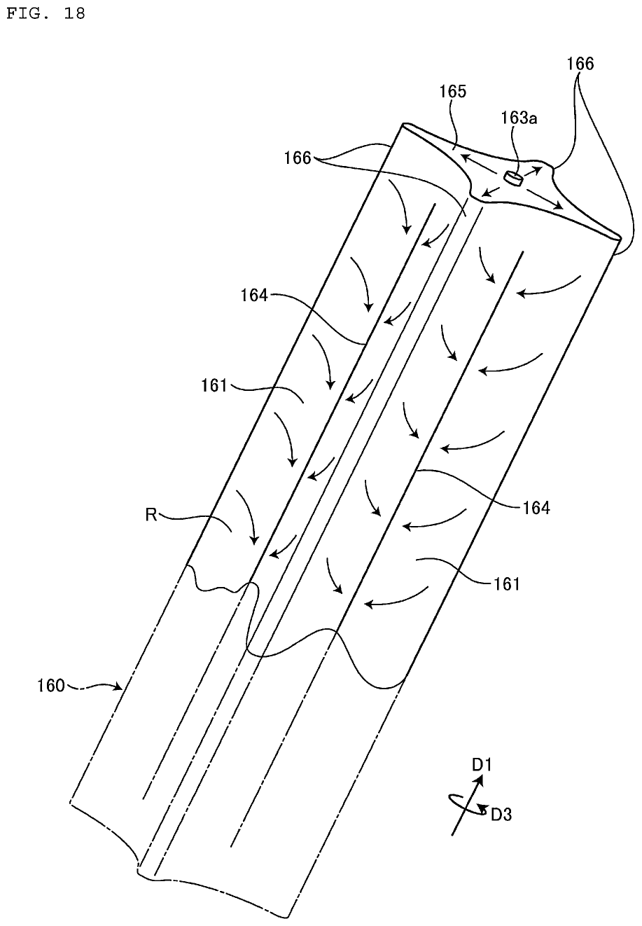

Next, a process of formation of the groove 164 in the first exterior member 160 will be described. FIG. 18 is a schematic view illustrating a process of formation of the first exterior member 160 by injection molding. An arrow illustrated in FIG. 18 indicates flow of the resin R which is a material of the first exterior member 160 during molding in a cavity of a mold of the first exterior member 160. A gate of a mold of the first exterior member 160 is located at a position corresponding to the projecting portion 163a of the first exterior member 160. That is, in the second embodiment, there is one gate of a mold.

The resin R flows into a cavity of a mold from one gate. Since thickness of the coupling portion 165b is larger than thickness of the base portion 165a, at a portion corresponding to the portion 165, a flow rate (flow rate per unit time, the same applies hereinafter) of the resin R from the gate (projecting portion 163a) toward a position corresponding to four of the portions 166 is higher than a flow rate of the resin R from the gate toward a position corresponding to a central portion of the portion 161 in the circumferential direction of the exterior member 152.

Further, since thickness of the portion 166 is larger than thickness of the portion 161, a flow rate of the resin R flowing through a portion corresponding to the portion 166 is higher than a flow rate of the resin R flowing through a portion corresponding to the portion 161, and the resin R flows through a portion corresponding to the portion 166 before a portion corresponding to the portion 161. By the above, as indicated by an arrow in FIG. 18, flow of the resin R from a portion corresponding to the portion 166 toward a position corresponding to a central portion of the portion 161 in the third direction D3 is generated. Therefore, the resin R flowing from a portion corresponding to the portion 166 hits at a portion corresponding to a central portion of the portion 161 in the third direction D3, and the groove 164 along the first direction D1 is generated.

As described above, since thickness of the coupling portion 165b is larger than thickness of the base portion 165a and thickness of the portion 166 is larger than thickness of the portion 161, flow of the resin R is adjusted, and the groove 164 along the first direction D1 is formed at a central portion of the portion 161 in the third direction D3. Further, as described above, since the intersection P of two of the diagonal lines L overlapping the coupling portion 165b in plan view of the portion 165 and the projecting portion 163a overlap each other, it is possible to uniformize flow rates of the resin R from a gate (the projecting portion 163a) toward four of the portions 166, and it is possible to form the groove 164 at a central portion of the portion 161 in the third direction D3.

Also in the exterior member 152 of the second embodiment, the groove 164 serves as a starting point of cleavage of the first exterior member 60 at the time of abnormal heat generation of the secondary battery 41, so that the heat absorbing member 50 can be easily cleaved at the time of abnormal heat generation of the secondary battery 41.

For example, it goes without saying that the number of the portions 161 and the portions 166 in the first exterior member 160 is not limited to four.

Further, the projecting portion 163a may be at a position other than a position overlapping the intersection P in plan view of the portion 165 (for example, a position where the projecting portion 163a overlaps the coupling portion 165b in plan view). Further, the coupling portion 165b may have a shape (for example, a linear shape and a T shape) of coupling with at least one of the portions 166 and the projecting portion 163a. In these cases as well, at the time of molding of the first exterior member 160, a flow rate of the resin R from a gate (the projecting portion 163a) toward a position corresponding to the portion 166 is higher than a flow rate of the resin R from the gate toward a position corresponding to a central portion of the portion 161 in the circumferential direction of the exterior member 152. Therefore, as in the second embodiment described above, the groove 164 is formed in the portion 161. However, if timings at which the resin R arrives are different between each of four of the portions 166, there is a case where the groove 164 is formed in a portion of the portion 161 other than a central portion of the portion 161 in the third direction D3.

Further, the coupling portion 165b may have a shape protruding toward the outer side of the first exterior member 160 from the outer surface S3. In this case, as in the second embodiment, at a portion corresponding to the portion 165 during molding of the first exterior member 160, a flow rate of the resin R from a gate (the projecting portion 163a) toward a position corresponding to four of the portions 166 is higher than a flow rate of the resin R from the gate toward a position corresponding to a central portion of the portion 161 in the circumferential direction of the exterior member 152. Therefore, as in the second embodiment described above, the groove 164 is formed in the portion 161.

Further, the first exterior member 160 does not need to include the coupling portion 165b. In this case, thickness of the portion 165 is constant. Further, in this case, as in the second embodiment, since thickness of the portion 166 is larger than thickness of the portion 161, a flow rate of the resin R flowing through a portion corresponding to the portion 166 is higher than a flow rate of the resin R flowing through a portion corresponding to the portion 161, and the resin R flows through a portion corresponding to the portion 166 before a portion corresponding to the portion 161. By the above, as indicated by an arrow in FIG. 18, flow of the resin R from a portion corresponding to the portion 166 toward a position corresponding to a central portion of the portion 161 in the third direction D3 is generated. Therefore, the resin R flowing from a portion corresponding to the portion 166 hits so that the groove 164.

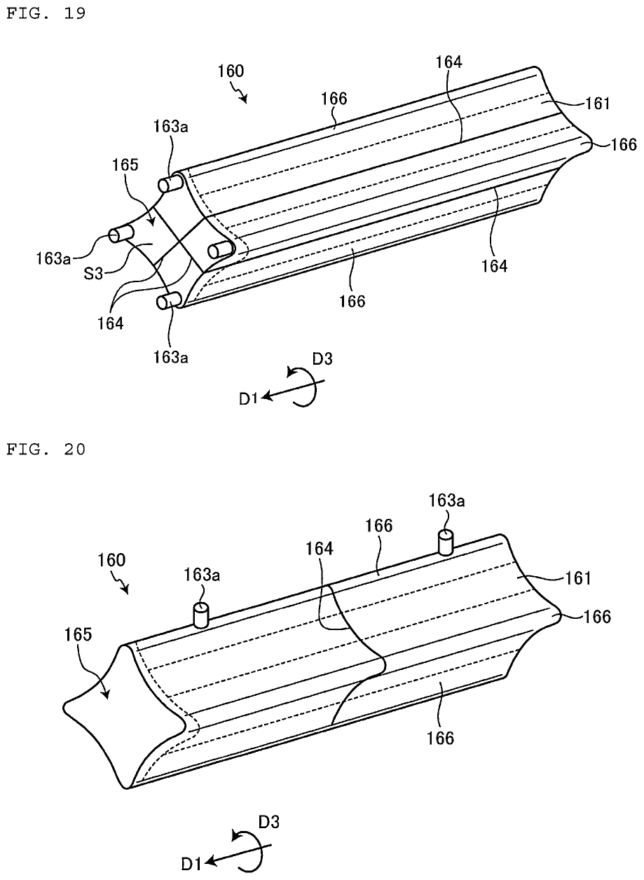

FIG. 19 is a diagram illustrating a position of the projecting portion 163a according to another variation of the second embodiment of the present disclosure. In the present variation, the number of the projecting portions 163a is four. Four of the projecting portions 163a are disposed on the outer surface S3. The projecting portion 163a overlaps the portion 166 when the first exterior member 160 is viewed along the first direction D1. In this case, similarly to the second embodiment, the groove 164 is formed so as to extend along the first direction D1 at a central portion in the third direction D3 in each of four of the portions 161. Further, the groove 164 is also formed in the portion 165. The grooves 164 of two of the portions 161 on the opposite sides to each other when the first exterior member 160 is viewed along the first direction D1 are connected to each other with the groove 164 of the portion 165 interposed therebetween. The groove 164 of the portion 165 has an X shape when the first exterior member 160 is viewed along the first direction D1.

FIG. 20 is a diagram illustrating a position of the projecting portion 163a according to another variation of the second embodiment of the present disclosure. In the present variation, the number of the projecting portions 163a is two. Two of the projecting portions 163a are located away from each other in the first direction D1 in one of the portion 166 of four of the portions 166. In this case, the groove 164 is formed to extend along the third direction D3 between two of the projecting portions 163a. Also in other variations illustrated in FIGS. 19 and 20, the groove 164 serves as a starting point of cleavage of the first exterior member 160 at the time of abnormal heat generation of the secondary battery 41, so that the heat absorbing member 150 can be easily cleaved at the time of abnormal heat generation of the secondary battery 41.

Note that the above-described embodiment and variation are for facilitating understanding of the present disclosure, and are not intended to the present disclosure in a limited manner. The present disclosure may be modified or improved without departing from the spirit of the present disclosure, and the present disclosure includes equivalents of the present disclosure.

Note that the present disclosure may be a combination of configurations below according to an embodiment.

(1)

A heat absorbing member including:
a heat absorbing agent; and
an exterior member that accommodates the heat absorbing agent, in which
the exterior member has a first portion that is in contact with an object, and
the first portion has a groove.
   (2)

The heat absorbing member according to (1), in which the first portion extends along a first direction, and a sectional shape of the first portion when cut along a plane orthogonal to the first direction is a recessed shape.

(3)

The heat absorbing member according to (2), in which
the exterior member further includes a second portion that is disposed on each of both sides of the first portion in a direction orthogonal to the first direction and is continuous from the first portion, and
the second portion has a projecting portion.
   (4)

The heat absorbing member according to (2) or (3), in which
a plurality of the first portions are provided, and
a plurality of the first portions are arranged in parallel along a direction orthogonal to the first direction.
   (5)

The heat absorbing member according to (2), in which
the exterior member has a columnar shape extending along the first direction, and further has a third portion intersecting the first direction on a first end side in the first direction,
the first portion is disposed continuously from the third portion, and
the third portion has a projecting portion.
   (6)

The heat absorbing member according to (5), in which
the exterior member further includes a fourth portion that is disposed on each of both sides of the first portion in a circumferential direction of the exterior member and is continuous from the first portion, and
thickness of the fourth portion is larger than thickness of the first portion.
   (7)

The heat absorbing member according to (6), in which
the third portion includes:
   a base portion; and
   a coupling portion that connects the fourth portion and the projecting portion, and
thickness of the coupling portion is larger than thickness of the base portion.
   (8)

The heat absorbing member according to (7), in which
the exterior member has four of the fourth portions and four of the first portions arranged in parallel along a circumferential direction of the exterior member,
the fourth portion connects two of the first portions adjacent to each other in the circumferential direction of the exterior member to each other,
the coupling portion connects two of the fourth portions facing each other in plan view of the third portion among four of the fourth portions and overlaps two diagonal lines intersecting each other, and
the projecting portion overlaps an intersection of two of the diagonal lines in the plan view.
   (9)

The heat absorbing member according to any one of (3) and (5) to (8), in which the projecting portion is a gate mark.

(10)

The heat absorbing member according to any one of (1) to (9), in which the groove is a weld line.

(11)

A battery pack including:
the heat absorbing member according to any one of (1) to (10); and
a secondary battery, in which
the object is the secondary battery.

### DESCRIPTION OF REFERENCE SYMBOLS

1: Battery pack
41: Secondary battery
50: Heat absorbing member
51: Heat absorbing agent
52: Exterior member
60: First exterior member
61: Portion (first portion)
62: Portion
63: Portion (second portion)
63a: Projecting portion
64: Groove
70: Second exterior member
165: Portion (third portion)
165a: Base portion
165b: Coupling portion
166: Portion (fourth portion)
D1: First direction
L: Diagonal line
P: Intersection

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A heat absorbing member comprising:
a heat absorbing agent; and
an exterior member that accommodates the heat absorbing agent, wherein
the exterior member has a first portion that is in contact with an object, and
the first portion has a groove.

2. The heat absorbing member according to claim 1, wherein
the first portion extends along a first direction, and
a sectional shape of the first portion when cut along a plane orthogonal to the first direction is a recessed shape.

3. The heat absorbing member according to claim 2, wherein
the exterior member further includes a second portion that is disposed on each of both sides of the first portion in a direction orthogonal to the first direction and is continuous from the first portion, and
the second portion has a projecting portion.

4. The heat absorbing member according to claim 2, wherein
a plurality of the first portions are provided, and
a plurality of the first portions are arranged in parallel along a direction orthogonal to the first direction.

5. The heat absorbing member according to claim 2, wherein
the exterior member has a columnar shape extending along the first direction, and further has a third portion intersecting the first direction on a first end side in the first direction,
the first portion is disposed continuously from the third portion, and
the third portion has a projecting portion.

6. The heat absorbing member according to claim 5, wherein
the exterior member further includes a fourth portion that is disposed on each of both sides of the first portion in a circumferential direction of the exterior member and is continuous from the first portion, and
a thickness of the fourth portion is larger than a thickness of the first portion.

7. The heat absorbing member according to claim 6, wherein
the third portion includes:
a base portion; and
a coupling portion that connects the fourth portion and the projecting portion, and
a thickness of the coupling portion is larger than a thickness of the base portion.

8. The heat absorbing member according to claim 7, wherein
the exterior member has four of the fourth portions and four of the first portions arranged in parallel along a circumferential direction of the exterior member,
the fourth portion connects two of the first portions adjacent to each other in the circumferential direction of the exterior member to each other,
the coupling portion connects two of the fourth portions facing each other in plan view of the third portion among four of the fourth portions and overlaps two diagonal lines intersecting each other, and
the projecting portion overlaps an intersection of two of the diagonal lines in the plan view.

9. The heat absorbing member according to a claim 3, wherein the projecting portion is a gate mark.

10. The heat absorbing member according to claim 1, wherein the groove is a weld line.

11. A battery pack comprising:
the heat absorbing member according to claim 1; and
a secondary battery, wherein
the object is the secondary battery.
